(19) United States
(12) Patent Application Publication
(10) Pub. No.: US 2011/0169409 A1
(43) Pub. Date: Jul. 14, 2011

(54) Led motorcycle lighting system

(76) Inventors: Glenn A. Stasky, Folsom, CA (US); George Scolaro, Sunnyvale, CA (US)

(21) Appl. No.: 12/654,974

(22) Filed: Jan. 11, 2010

(51) Int. Cl. B60Q 1/14

(52) U.S. Cl. 315/77

(57) ABSTRACT

The LED motorcycle lighting system is designed to help improve visibility of riders during night and day riding. The system includes an array of LED lights disposed in a housing adapted for mounting on a weight-balanced bracket. The weight-balanced bracket is adapted for mounting on a motorcycle's caliper mount to secure the LED lamp to the vehicle. Using two weight-balanced mounting brackets, a first LED lamp is mounted on the left front of the motorcycle, while a second LED lamp is mounted on the right front of the motorcycle. The system uses pulse width modulated current drivers fed by an adjustable PWM signal to allow brightness adjustment of the lights by the user to suit a particular riding situation. A handlebar-mounted potentiometer adapted for adjusting the PWM signal provides easy access to the user for brightness control of the lights.

### BACKGROUND OF THE INVENTION

1. Field of the Invention

The present invention relates to motorcycle roadway lights, and more specifically to an LED motorcycle lighting system that provides a caliper-mounted roadway light having an LED brightness controller.

2. Description of the Related Art

Lighting systems for motorcycles are important to provide illumination of driving surfaces in dark or low visibility conditions and to improve the visibility of motorcycles to other vehicles and pedestrians. While motorcycles have typically been provided with a main headlight for illuminating the road ahead of the motorcycle, headlights are generally mounted high on the handlebars, and thus illumination of the road immediately in front of the motorcycle is degraded. To improve the illumination of the road, many motorcycle operators choose to add accessory lights on lower portions of the motorcycle to supplement the illumination provided by the main headlight.

In addition to providing improved illumination of the road, such accessory lighting may also provide benefits in terms of improved safety. While headlights may be visible to drivers of other vehicles on the road, the fact that motorcycles generally have a single headlight, or closely spaced pairs of headlights, makes it difficult for other drivers to adequately determine the distance and rate of speed of a motorcycle moving toward them. The frequency of accidents involving motorcycles may be decreased when the motorcycles are provided with additional lights, which are lower than the headlight and spaced on opposite sides of the motorcycle to provide additional visual references for determining the distance and rate of speed of an approaching motorcycle. This is especially true when the motorcycle driver is given the opportunity to adjust the brightness of the accessory lighting to suit a particular riding situation.

Accordingly, there is a need for a brightness adjustable accessory riding light for motorcycles that can be easily mounted to existing structure of the motorcycle and which does not require extensive modification of the motorcycle.

Thus, an LED motorcycle lighting system solving the aforementioned problems is desired.

### SUMMARY OF THE INVENTION

The LED motorcycle lighting system is designed to help improve the visibility of motorcycle riders during night and day riding. The system includes an array of LED lights disposed in a housing adapted for mounting on a weight-balanced bracket. The weight-balanced bracket is adapted for mounting on a motorcycle's caliper mount to secure the LED lamp to the vehicle. Using two weight-balanced mounting brackets, a first LED lamp is mounted on the left front of the motorcycle, while a second LED lamp is mounted on the right front of the motorcycle. The system uses pulse width modulated current drivers fed by an adjustable PWM signal to allow brightness adjustment of the lights by the user to suit a particular riding situation. A handlebar-mounted potentiometer adapted for adjusting the PWM signal provides easy access to the user for brightness control of the lights.

These and other features of the present invention will become readily apparent upon further review of the following specification and drawings.

### BRIEF DESCRIPTION OF THE DRAWINGS

FIG. 1 is a block diagram of a motorcycle LED lighting system according to the present invention

FIG. 2 is an environmental perspective view of a LED array mounted to a motorcycle according to the present invention.

FIG. 3 is an environmental perspective view of a LED array control mounted to a motorcycle handlebar according to the present invention.

FIG. 4 is a block diagram of the electrical connection of a LED lighting system according to the present invention.

FIG. 5 is a circuit diagram showing the microprocessor of a LED lighting system according to the present invention.

FIG. 6 is a front environmental perspective view of a LED array mounted to a motorcycle according to the present invention.

FIG. 7 is an exploded perspective view of a LED array assembly being mounted to a motorcycle caliper mount according to the present invention.

Similar reference characters denote corresponding features consistently throughout the attached drawings.

### DETAILED DESCRIPTION OF THE PREFERRED EMBODIMENTS

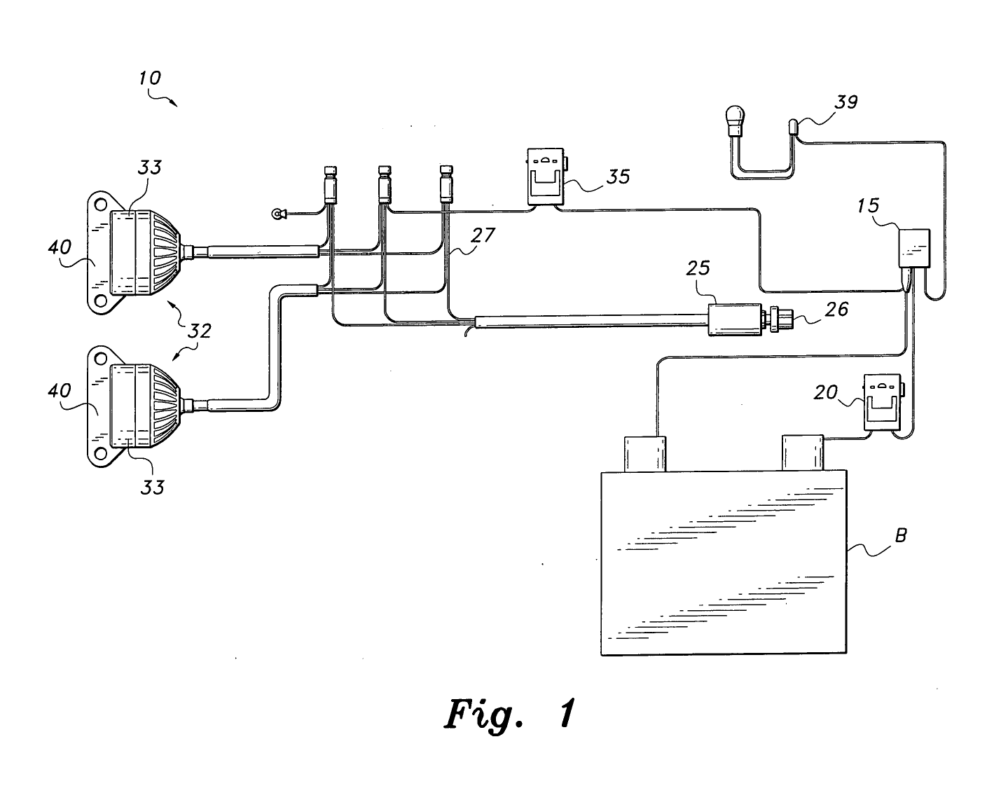

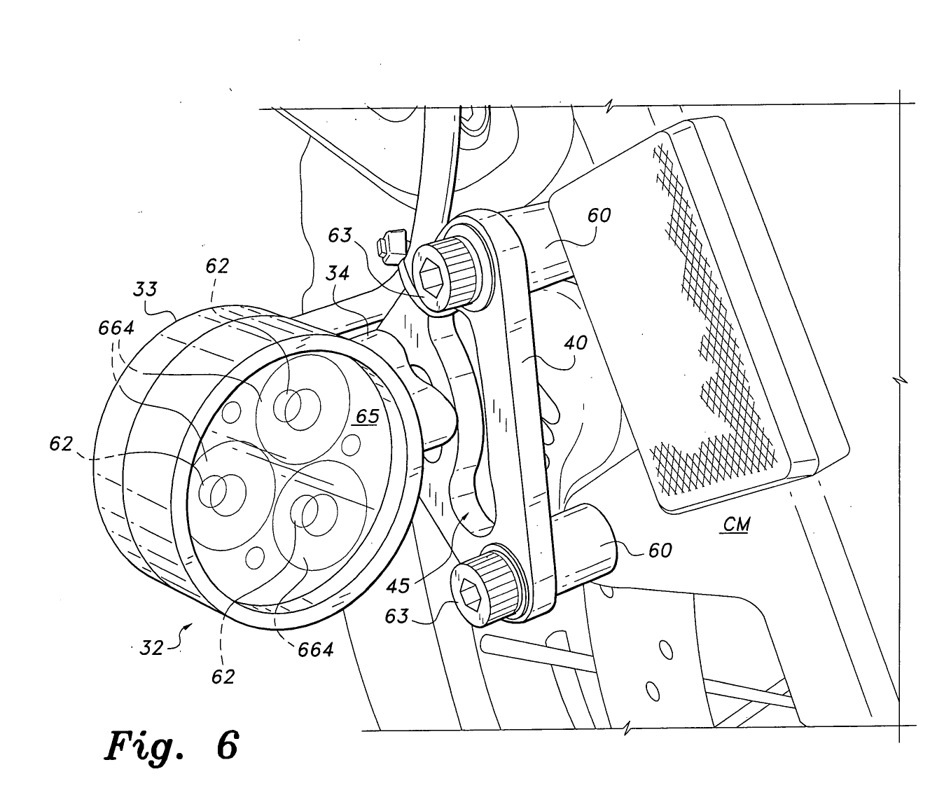

As shown in FIGS. 1 and 6, the LED motorcycle lighting system 10 is comprised of a riding light 32 that includes a Light emitting Diode (LED) array 62 which produces a bandwidth of light which facilitates visibility of the rider to other vehicles and visibility of the road to the rider. The LED array riding lamp 32 incorporates a pulse width modulation (PWM) “dimming” system to allow use in all environmental lighting situations.

While the LED array riding lamp 32 can be mounted in various locations on a motorcycle, a preferred mounting position is on a caliper mount CM of the front wheel proximate the brake caliper. Preferably the LED array riding lamp 32 is mounting as far away as possible from the original headlights on the motorcycle. This configuration gives the on-coming motorist a better chance to judge direction, speed and distance of the motorcycle. Referring to FIGS. 1, 4, 5A-5B, a preferred embodiment is shown in which two LED array riding lamps 32 are connected to one of current drivers 400 and 402 controlled by microprocessor 502, the current drivers 400 and 402 being connected via wiring harness 27 to the factory bulb socket connection 39 of a motorcycle's electrical system. If the motorcycle uses CANBUS technology, the wiring harness 27 may be a. CANBUS relay harness. The relay harness may be comprised of silver plated Teflon insulated wiring. The wiring harness cable is preferably silicone lubricated internally to help prevent vibration damage to the wiring of harness 27. The lamp housing 33 supports the LED array 62, and a bracket 40 is configured to mount the housing 33 to a caliper mount CM proximate a front brake caliper 700 on a motorcycle. Accordingly, both lamps 32 may easily be installed on the motorcycle by removing a pre-existing brake caliper fastener, positioning the riding light adjacent the brake caliper fastener hole proximate the caliper mount CM, and installing standoff bushings 60, then fastening the assembly with a substitute fastener 63 having a longer shank than the original brake caliper fastener had.

The PWM is generated by the microprocessor 502 which preferably can change the duty cycle of the voltage driving the lamps 32 at a very quick rate, e.g., approximately 240 Hz. The exemplary microprocessor 502 is an ATMEL TINY45V, which has approximately 8 KB of memory and includes flash memory for storing a list of values representing dimming curves for LED array riding lamps 32 in the present invention. Advantageously, the human eye interpolates the “high” pulses with the “off” time and processes this as a dimming function.

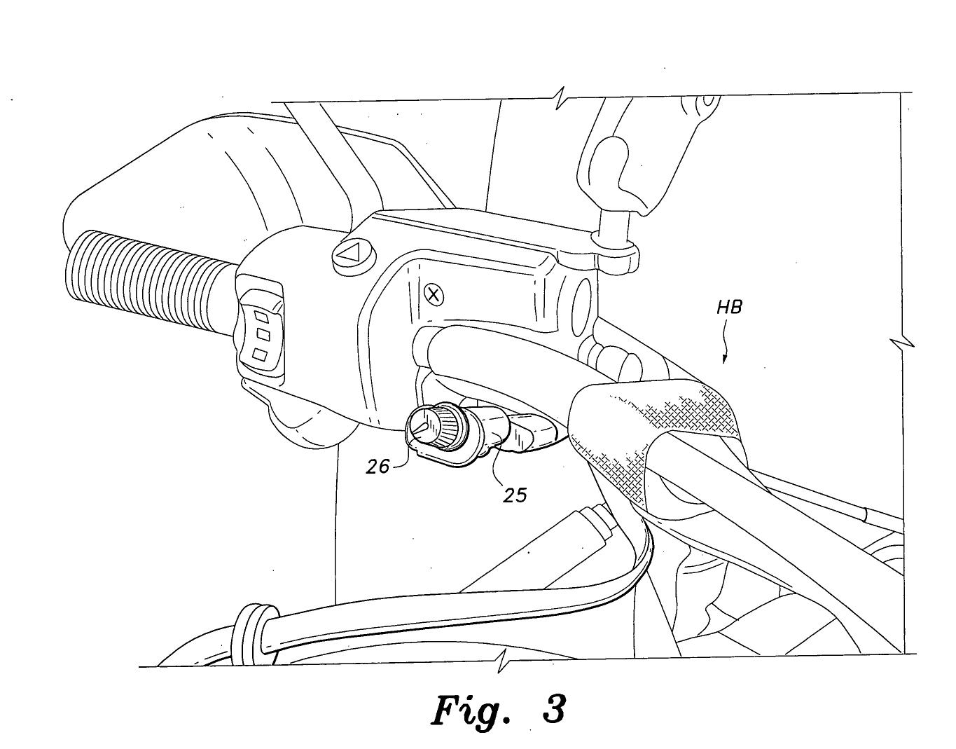

A control potentiometer 26 connected to an analog to digital (A/D) converter in the microprocessor 502 digitally encodes the PWM signal to each of the constant current drivers 400 and 402 connected to the LED lamps 32. Constant current driver 400 is a 1000 mA constant current device, while constant current driver 402 is a 2800 mA constant current device. Micro Controller 502 utilizes two of its PWM outputs, which are buffered to simultaneously control the two LED drivers 400 and 402. By adjusting the potentiometer 26, the motorcyclist can brighten or dim the lamps as desired. As shown in FIG. 3, the potentiometer 26 and its rear housing 25 are mounted on handlebar HB of the motorcycle for ease of use by the cyclist.

Moreover via the two LED drivers 400 and 402, the inventive apparatus can control a low power version of LED array riding lamps 32 that provides an accent light to make the rider conspicuous and a high power version of LED array riding lamps 32 that more fully illuminates the driving environment. Both outputs are functional and can be adjusted via control potentiometer 26.

Additionally, the riding light system 10 may have a “Hi-Low” relay 15 connected to a user operated switch that could be coupled to or in close proximity with potentiometer 26 which has a HI selection and a LO selection. A 30-ampere fuse 20 protects the wiring portion of the system 10 proximate lead of battery B. A 5-ampere fuse 35 protects wiring of the system 10 “downstream” from the battery B and relay 15. Placing the switch in the HI position selects the motorcycle's HIGH beam, interrupts the PWM signal from microprocessor 502 and applies 100% duty cycle to the LED current drivers 400, 402 so that the LED riding lamps 32 are at their brightest setting. When the LOW beam is selected, the relay 15 engages the PWM signal driven by microprocessor 502 and the lights 32 again respond to the set level of potentiometer 26. Thus, the motorcyclist can quickly adjust the light output when approaching oncoming traffic.

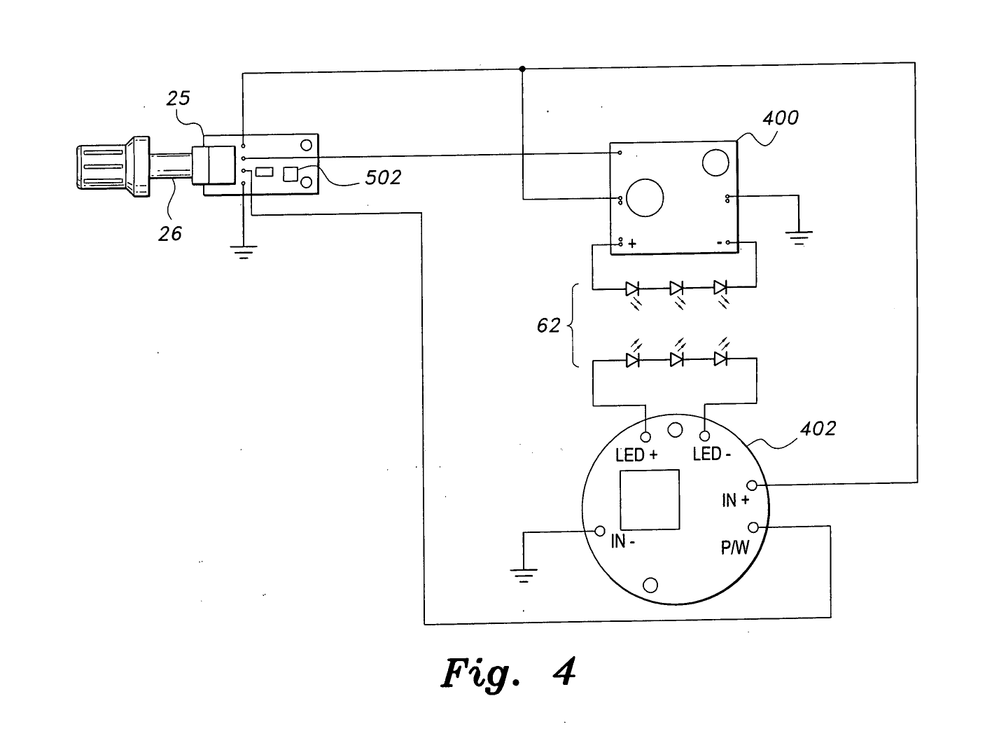

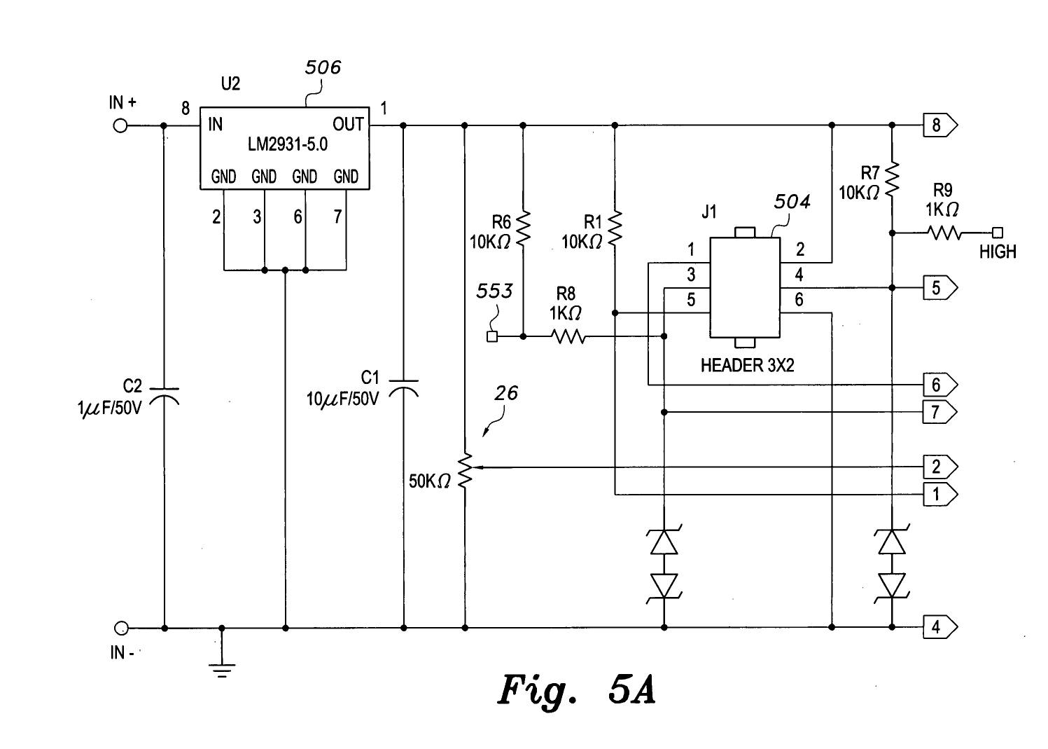

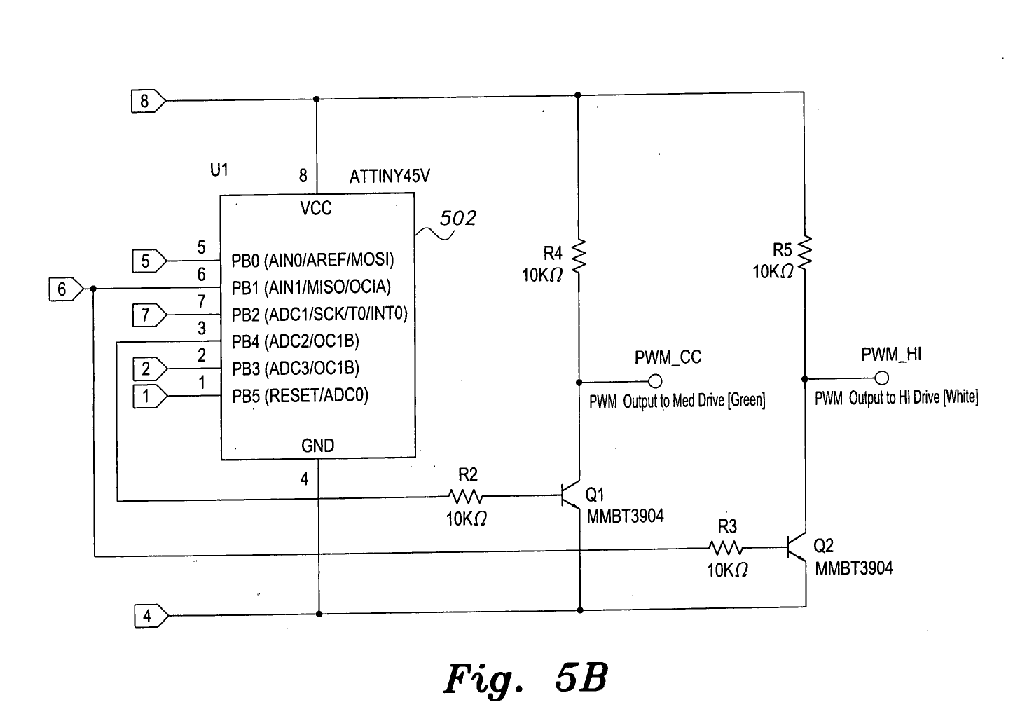

As shown in FIGS. 4, 5A-5B, the LED driver is comprised of a current regulated dc to dc switching regulator 506 which keeps voltage to the system in a predetermined nominal range irrespective of load demanded by the LED array riding lamps 32. Header 504 provides an interface for programming the microcontroller 502 and writing dimmer response data into flash memory of microcontroller 502.

The drivers 400, 402 can support LED array 62 which may be comprised of at least one, and is preferably three series connected white LED's. The drivers 400, 402 operate under a nominal 12V motorcycle or vehicle electrical supply. Exemplary LED driver 402 has a PWM input to enable dimming of the LED array 62. Dimming is implemented by varying the duty cycle of the constant current source provided by exemplary LED driver 402. Control potentiometer 26 connected to an analog to digital converter in the microprocessor 502 digitally encodes the PWM signal to each of the constant current drivers 400 and 402 connected to the LED lamps 32.

Rear portion 25 of the control potentiometer 26 is preferably mounted in close proximity to the processor 502. The control potentiometer 26 may be of any type including log, linear, semi log etc. The potentiometer 26 is disposed in the control circuitry in a voltage divider configuration that provides a variable analog voltage to an analog to digital converter in the microcontroller 502 which then, based on comparison of the digital value to values stored in flash memory of processor 502 outputs a resultant digital PWM duty cycle.

The tabular values are read by processes running in processor 502, which then maps the position of potentiometer 26 as required to provide a dimming curve that is appropriate for a motorcycle/vehicle auxiliary light. An added feature is that the maximum brightness setting, i.e., maximum average current setting, of potentiometer 26 (PWM output) can be arbitrarily set within flash memory of processor 502 to provide a safe operating temperature of the LED array riding lamps 32. Additional thermal protection circuitry is provided by the use of a small thermal probe 553 (shown in FIG. 5A) attached to a circuit board upon which the LED array 62 is mounted, the probe monitoring LED surface temperature. At a predetermined temperature, the probe 553 sends a calibrated resistance to the PWM circuit. At elevated temperatures, LED's can have diminished life spans. This calibrated circuit can intervene and roll back the duty cycle until temperature drops below the predetermined level. This feature helps prolong the life of the LED's 62 under elevated environmental temperatures.

The controller 502 is programmed with a set of instructions which cause the controller 502 to accept a command from the user via potentiometer 26 in which the user rotates the potentiometer 26 to its high limit and then to its low limit quickly low/high/low/high a specified number of times within the initial few seconds of power application to toggle/cycle the control device 502 to chose a specific potentiometer-pwm mapping table in memory, as there may be either a single table or a plurality of tables to chose from. This enables the user to select from a variety of current output tables, e.g., a conservative maximum output table may be selected or a full power output table may be selected.

As shown below in the tables, an exemplary embodiment of the present invention includes two tables for a high powered version of LED array 62 and two tables for a 1000 ma version of LED array 62. Additionally, third and fourth tables are provided for a 2800 ma version of LED array 62. Preferably there are 64 dimming levels per table. It should be understood that each table may be independently custom tuned via data input through the programming header 504 for specific driver usage and for low or high modes. By clever programming of the tables, a daytime running light position can be implemented. That is to say, the lowest level in the table will dim, but not turn off the LED array riding lamps 32. Exemplary dimmer tables representing ratio of x/240 or x/243) are illustrated in the tables below.

TABLE 1
(pwm_table_1000 mA (high)[64] PROGMEM)

| | | | | | | | |
|---|---|---|---|---|---|---|---|
| 0 | 8 | 16 | 24 | 32 | 40 | 47 | 54 |
| 61 | 68 | 75 | 82 | 88 | 94 | 100 | 106 |
| 112 | 118 | 124 | 130 | 135 | 140 | 145 | 155 |
| 161 | 165 | 168 | 171 | 174 | 177 | 180 | 183 |
| 186 | 189 | 192 | 195 | 198 | 200 | 202 | 204 |
| 206 | 208 | 210 | 212 | 214 | 216 | 218 | 220 |
| 222 | 224 | 226 | 228 | 230 | 231 | 233 | 235 |
| 236 | 237 | 238 | 239 | 240 | 241 | 242 | 243 |

TABLE 2
(pwm_table_1000 mA (low)[64] PROGMEM)

| | | | | | | | |
|---|---|---|---|---|---|---|---|
| 72 | 78 | 83 | 88 | 93 | 97 | 102 | 105 |
| 110 | 115 | 120 | 125 | 130 | 138 | 122 | 126 |
| 130 | 134 | 138 | 141 | 145 | 149 | 153 | 157 |
| 161 | 165 | 168 | 171 | 174 | 177 | 180 | 183 |
| 186 | 189 | 192 | 195 | 198 | 201 | 204 | 207 |
| 210 | 213 | 216 | 218 | 220 | 222 | 223 | 224 |
| 225 | 227 | 229 | 231 | 232 | 233 | 234 | 234 |
| 236 | 237 | 238 | 239 | 240 | 241 | 242 | 243 |

TABLE 3
(pwm_table_2800 mA (high)[64] PROGMEM)

| | | | | | | | |
|---|---|---|---|---|---|---|---|
| 0 | 8 | 16 | 24 | 32 | 40 | 47 | 54 |
| 61 | 68 | 75 | 82 | 88 | 94 | 100 | 106 |
| 112 | 118 | 124 | 130 | 135 | 140 | 145 | 155 |
| 161 | 165 | 168 | 171 | 174 | 177 | 180 | 183 |
| 186 | 189 | 192 | 195 | 198 | 201 | 204 | 206 |
| 208 | 210 | 212 | 214 | 216 | 218 | 220 | 221 |
| 223 | 225 | 226 | 228 | 229 | 230 | 231 | 232 |
| 233 | 234 | 235 | 236 | 237 | 238 | 239 | 240 |

TABLE 4
(pwm_table_2800 mA (low)[64] PROGMEM)

| | | | | | | | |
|---|---|---|---|---|---|---|---|
| 56 | 62 | 67 | 72 | 77 | 82 | 88 | 93 |
| 98 | 103 | 108 | 112 | 116 | 120 | 124 | 128 |
| 132 | 136 | 140 | 144 | 148 | 152 | 156 | 160 |
| 164 | 168 | 171 | 175 | 178 | 181 | 184 | 187 |
| 190 | 192 | 194 | 196 | 198 | 200 | 202 | 204 |
| 206 | 208 | 210 | 212 | 214 | 216 | 218 | 220 |
| 222 | 224 | 226 | 228 | 229 | 230 | 231 | 232 |
| 233 | 234 | 235 | 236 | 237 | 238 | 239 | 240 |

The tables in flash memory of processor 502 are “tunable” for specific needs and may provide either a linear or a non-linear mapping to actual duty cycle of the PWM signal delivered to the current drivers 400 and 402. Since the human eye is more sensitive to small intensity changes when dim, the table is preferably tuned to ‘smooth’ the transitions between the discrete value steps in the table.

To execute the aforementioned PWM brightness control for LED array riding lamps 32 of the present invention, it is contemplated that a computer product comprising a medium readable by processor 502, has a set of instructions readable by processor 502 thereon, the set of instructions being executable by processor 502 when loaded into instruction memory of the processor 502. For controlling brightness level of LED array riding lamps 32, the aforementioned set of instructions running on processor 502 cause the processor 502 to read a digital number obtained by A/D conversion of analog voltage input to the A/D converter, the analog voltage being determined by setting of control potentiometer 26, and to index into the active PWM table using the read digital number.

The set of instructions further causes processor 502 to retrieve a table entry specified by the aforementioned PWM table indexing procedure. The processor 502 then uses the retrieved table entry value as a new parameter to adjust its PWM output thereby brightening or dimming the LED array riding lamps 32 (if the retrieved table entry value is lower than the previously retrieved value, the lamps 32 dim; if the retrieved table entry value is higher than the previously retrieved value, the lamps 32 brighten). It should be understood that the magnitude of the value difference between consecutive PWM table entries determines the perceived difference in brightness of lamps 32 as the processor 502 traverses the table entries responsive to a user adjusting potentiometer 26, hence the PWM tables are custom tunable by the designer to achieve a desired brightness/dimming profile.

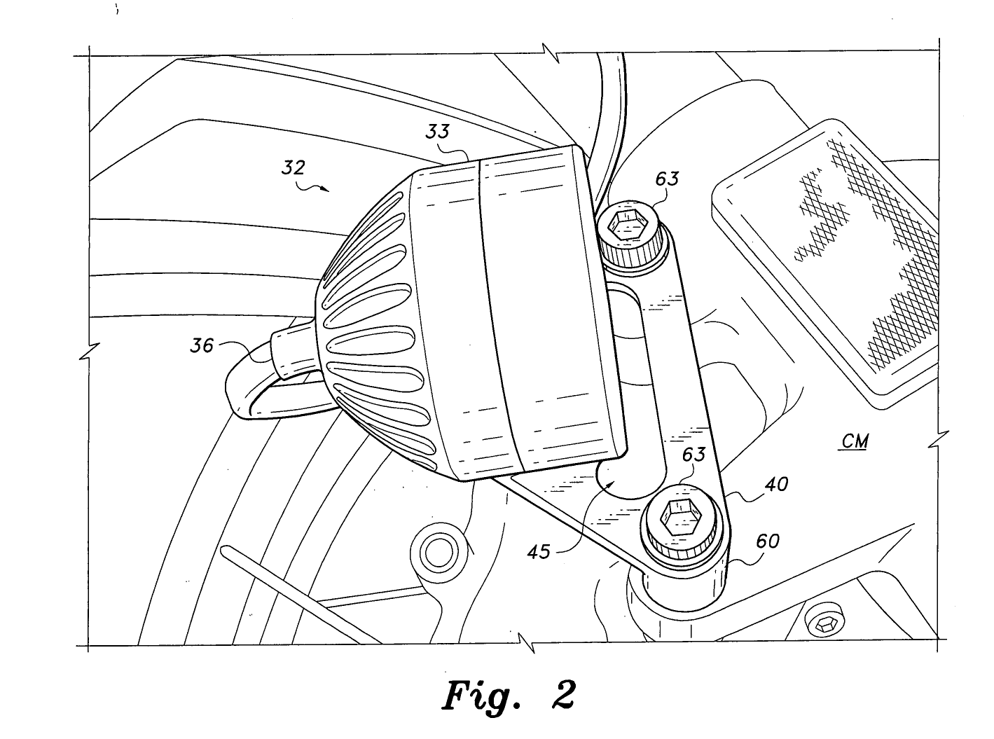

As shown in FIGS. 2, 6, and 7, the LED array riding lamp 32 has a housing 33 particularly suited for mounting on the front brake caliper mounting portion CM of a motorcycle. Components of housing 33 may be fitted together using a gasket system of O rings and threaded rings to give the internal elements a secure seal. Moreover, the main body of lamp 32 is preferably machined (under computer control for accuracy) from a solid billet of aluminum. The lamp 32 has cooling fins that are machined out of a grain oriented billet for maximum strength. A riding lamp mounting bracket 40 and the brake caliper 700 are positioned on opposing sides of the caliper mount CM and then fastened to the caliper mount CM.

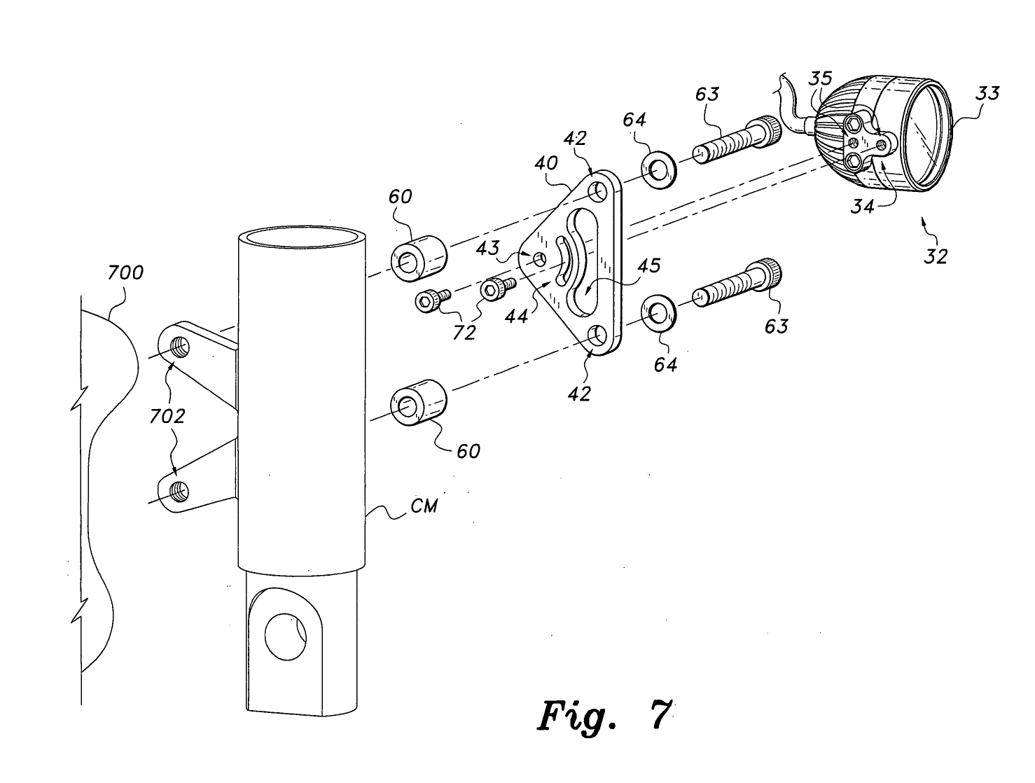

Caliper mount CM is a structural element of the motorcycle and includes at least one threaded through-bore 702 (see FIG. 7) to which the brake caliper assembly 700 is mounted by threaded bolts 63 which engage washers 64, riding light mounting bracket 40, standoff bushings 60 and aligned holes in brake caliper assembly 700.

Standoff bushings 60 provide sufficient clearance in riding lamp mounting bracket 40 from the motorcycle's caliper mount CM such that mounting position of the LED array riding lamp 32, avoids interference with other components of the motorcycle while positioning the LED array riding lamp 32 at a position which illuminates the road ahead of the motorcycle.

It will be recognized that fasteners 63 are preferably longer than the original caliper fasteners to account for the aggregate thickness of washers 64, LED array riding lamp mounting bracket 40, and standoff bushings 60. In this manner, LED array riding lamp 32 “piggy backs” on the brake caliper mounting bracket CM such that a lengthened version fastener 63 is used to fasten both the LED array riding lamp 32 and the brake caliper assembly 700 to the caliper mount CM on the motorcycle.

The LED array riding lamp mounting bracket 40 is an isosceles triangular shaped member having caliper mount mounting holes 42 disposed on opposing ends of the long sided portion of the member. The aforementioned bracket fasteners 63 go through the caliper mount mounting holes 42. An LED array riding lamp pivot mounting hole 43 is disposed proximate the apex of isosceles triangular shaped mounting bracket 40. Interior portion of the member 40 has an arcuate lamp mounting aperture 44 symmetrically extending between the opposing iso-sides which allows a mounted LED array riding lamp 32 to be pivotally adjusted to a desired angle before tightly securing the lamp to the bracket 40 at aperture 44 with one of the lamp mounting threaded fasteners 72. The other lamp mounting threaded fastener 72 is disposed through the pivot hole 43. A second “balancing” aperture 45 is disposed below the lamp mounting aperture 44. The balancing aperture 45 allows the bracket member 40 to be balanced at its centroid.

An LED array riding lamp mounting boss 34 extends from the bottom of lamp housing 33. Both lamp mounting threaded fasteners 72 are threaded into threaded bores 35 of LED array riding lamp mounting boss 34 to secure the lamp housing 33 to bracket 40. A wiring cable 36 extends out of the rear portion of lamp housing 33 and is routed to the wiring harness 27 (shown in FIG. 1).

As most clearly shown in FIG. 6, the housing 33 of LED array riding lamp 32 secures a lens 65, which protects the array of LEDs 62. A reflector 664 surrounds each individual LED of the array 62.

It is to be understood that the present invention is not limited to the embodiment described above, but encompasses any and all embodiments within the scope of the following claims.

I claim:

1. An LED motorcycle lighting system, comprising:
a housing having an opening covered by a lens;
an array of light emitting diodes disposed within the housing;
a mounting boss extending outwardly from the housing;
a pulse width modulated current driver, the pulse width modulated current driver being adapted for receiving power from a motorcycle's battery;
an insulated electrical wire having a first end electrically connected to the array of light emitting diodes and a second end extending outwardly from the rear portion of the housing, the second end being electrically connected to an output of the pulse width modulated current driver;
a control device adjustable by a user, the control device controlling frequency and pulse width of a signal sent to the pulse width modulated current driver responsive to adjustments of the control device by the user, the pulse width modulated current driver output responsively adjusting a brightness level of the array of light emitting diodes; and
a planar bracket member having a pivot hole, a first mounting hole, a second mounting hole, a first aperture and a second aperture formed therethrough, the pivot hole being adapted for securing the mounting boss to the bracket member, the first aperture being adapted for adjustably mounting the housing thereto, the second aperture being adapted for maintaining weight balance of the bracket member at a centroid of the bracket member, the first and second mounting holes being adapted for mounting on a motorcycle.

2. The LED motorcycle lighting system according to claim 1, wherein said adjustable control device is a potentiometer.

3. The LED motorcycle lighting system according to claim 1, wherein said potentiometer is a rotary mechanical control adjustable by the user.

4. The LED motorcycle lighting system according to claim 1, wherein said light emitting diode array has a perceived brightness level change linearly related to adjustment of the adjustable control device by the user.

5. The LED motorcycle lighting system according to claim 1, wherein said light emitting diode array has a perceived brightness level change non-linearly related to adjustment of the adjustable control device by the user.

6. The LED motorcycle lighting system according to claim 1, further comprising a microcontroller accepting input from said control device, the microcontroller responsively adjusting frequency and pulse width of the signal sent to said pulse width modulated current driver, thereby adjusting the brightness level of said array of light emitting diodes.

7. The LED motorcycle lighting system according to claim 6, wherein said microcontroller includes a look-up table of pulse width modulation control values, the look-up table being indexed by a setting of said adjustable control device, an indexed pulse width modulation control value adjusting the PWM signal sent to said pulse width modulated current driver.

8. The LED motorcycle lighting system according to claim 7, wherein said look-up table has pulse width modulation control values adapted for control of a low current version of said LED array.

9. The LED motorcycle lighting system according to claim 7, wherein said look-up table has pulse width modulation control values adapted for control of a high current version of said LED array.

10. The LED motorcycle lighting system according to claim 7, wherein said microcontroller has a plurality of said look-up tables, each of said look-up tables defining a unique brightness adjustment profile selectable by the user.

11. The LED motorcycle lighting system according to claim 10, wherein said microcontroller includes a circuit for accepting a predetermined sequence of user adjustments to said adjustable control device, the predetermined sequence of user adjustments selecting one of said look-up tables defining the unique brightness adjustment profile.

12. The LED motorcycle lighting system according to claim 1, wherein said planar bracket member has the shape of an isosceles triangle, the first and second mounting holes being disposed proximate opposite ends of a long side of said planar bracket member, the pivot hole being disposed proximate an apex formed by opposing equal sides of said planar bracket member, the first aperture being arcuate and disposed through an interior portion of said planar bracket member below the pivot hole, the first aperture symmetrically extending between the opposing equal sides of said planar bracket member, the second aperture being disposed through an interior portion of said planar bracket below the first aperture.

13. The LED motorcycle lighting system according to claim 1, wherein said adjustable control device is adapted for mounting on a handlebar of the motorcycle for ease of use by the cyclist.

14. The LED motorcycle lighting system according to claim 1, further comprising a switch connected to the LED motorcycle lighting system and adapted for connection to an electrical system of the motorcycle, the switch having a hi beam position and a low beam position, the switch disengaging the PWM signal and applying a steady-state high beam voltage from the motorcycle's electrical system when the hi beam position is selected, the switch engaging the PWM signal when the low beam position is selected.

15. The LED motorcycle lighting system according to claim 1, further comprising an LED array surface temperature monitoring control probe disposed proximate said LED array, said control probe reducing said pulse width modulation signal duty cycle when LED array temperatures exceed a predetermined threshold.
